(19) United States
(12) Patent Application Publication
(10) Pub. No.: US 2008/0101073 A1
(43) Pub. Date: May 1, 2008

(54) Dental Light Devices Having an Improved Heat Sink

(75) Inventors: Robert Hayman, Los Angeles, CA (US); Younes Shabany, San Jose, CA (US); Eric P. Rose, Tarzana, CA (US)

Correspondence Address: DISCUS DENTAL IMPRESSIONS, INC., 8550 HIGUERA STREET, CULVER CITY, CA, 90232, US

(73) Assignee: DISCUS DENTAL, LLC, Culver City, CA (US)

(21) Appl. No.: 11/928,096

(22) Filed: Oct. 30, 2007

Related U.S. Application Data
(62) Division of application No. 11/591,891, filed on Nov. 1, 2006.

(51) Int. Cl. F21V 29/00

(52) U.S. Cl. 362/373

(57) ABSTRACT

The present invention relates to a heat sink material that can more efficiently remove or divert heat from a light source or sources with a given weight of heat sink material when compare to a heat sink made of a solid block of thermally conductive material such as metal. It further relates to a heat sink that can more efficiently remove or divert heat from a curing light device when a reduced weight of heat sink material is used. The inventive heat sink has at least one suitable phase change material including organic materials, inorganic materials and combinations thereof. These materials can undergo substantially reversible phase changes, and can typically go through a large, if not an infinite number of cycles without losing their effectiveness.

### CROSS-REFERENCE TO RELATED APPLICATIONS

This application claims the benefit of U.S. provisional application Ser. Nos. 60/585,224, filed Jul. 2, 2004, entitled “Dental Light Devices With Phase Change Heat Sink”; 60/658,517, filed Mar. 3, 2005, entitled “Apparatus and Method For Radiation Spectrum Shifting in Dentistry Application”; 60/641,469, filed Jan. 4, 2005, entitled “Lamp For Dentistry Applications”; 60/647,580, filed Jan. 26, 2005, entitled “Light Guide For Dental Whitening Lamp”; 60/641,468, filed Jan. 4, 2005, entitled “Light Guide For A Dental Whitening Lamp”; 60/647,612, filed Jan. 26, 2005, entitled “Light Path Apparatus For A Dental Lamp”; 60/604,577, filed Aug. 25, 2004, entitled “Lip Retractors”; 60/594,297, filed Mar. 25, 2005, entitled “Curing Light Having A Detachable Tip”; 60/631,267, filed Nov. 26, 2004, entitled “Curing Light Having A Reflector”; 60/594,327, filed on Mar. 30, 2005, entitled, “Curing Light”; and 60/664,696, filed Mar. 22, 2005, entitled “Curing Light Having A Detachable Tip”; the contents of all of which are hereby incorporated by reference.

The present application includes claims that may be related to the claims of co-pending U.S. patent applications Ser. No. 11/173,839, to be concurrently filed, entitled “Illumination System for Dentistry Applications”; Ser. No. 11/173,709, to be concurrently filed, entitled “Voice Alert System for Dentistry Applications”; Ser. No. 11/173,297, to be concurrently filed, entitled “Retracting Devices”; Ser. No. 11/173,734, to be concurrently filed, entitled “Light Guide for Dentistry Applications”; and Ser. No. 11/173,731, to be concurrently filed, entitled “Support System for Dentistry”; the contents of all of which are hereby incorporated by reference.

### FIELD OF THE INVENTION

The present invention relates to any device suitable for photocuring, or photobleaching in general. Particularly, it relates a photocuring, or photobleaching device suitable for curing dental composites or acting on a whitening gel, respectively, having an improved heat sink.

### BACKGROUND OF THE INVENTION

Composite resin fillings have become the standard for filling cavities in dentistry today. These composite fillings use resins that must be cured after application. Handheld curing lights have been extensively used for this curing purpose. The lights can be held in close proximity to the composite resin materials residing in patients' mouths. The exposure times required for curing the composite materials depend on the types of composite resins used. Thus, the lighter the handhelds, the easier it is for the dental professionals who have to hold such devices in place to effect curing.

At the same time teeth bleaching is also routinely done by dental professionals. One type of bleaching composition is photoactivated. During photobleaching, a bleaching light is utilized.

Heat generated by any curing lights during operation can be problematic. Industry safety standards dictate that the external surface temperature of the curing light cannot exceed 50° C. Additionally, the duration or run time before the curing light overheats and shuts off is dependent on how much and how quickly heat can be removed from the curing light. This same kind of problem is also encountered in photobleaching lights. Therefore, any efficient way of heat removal is desirable for both curing and photobleaching lights.

Various ways have been attempted to remove the heat generated. One common way is through the use of metal heat sinks, such as blocks of copper, and cooling fans contained within the curing or photobleaching light. Some devices use a combination of heat sinks and cooling fans to facilitate removal.

Blocks of metal can be efficient, but they can also add significant weight to any hand held curing light. The added weight can in turn contribute to increased fatigue of the dental professional using the curing light. When a fan is also used in the same curing light, it adds additional weight, can be noisy and can contribute to reduced battery life and reliability of the device. The noise also adds to the anxiety of the patients who are often reluctant and fearful of dental procedures.

Although devices used for photobleaching and some curing lights are supported during use so that any added weight is not as problematic as a portable curing light device, a more efficient heat sink can also be beneficial, contributing to the design of a more compact device. Therefore, there remains a need for a device that will more efficiently divert or remove heat from the light source without additional weight.

### SUMMARY OF THE INVENTION

The present invention relates to a heat sink material that can more efficiently remove or divert heat from a light source or sources with a given weight of heat sink material when compare to a heat sink made of a solid block of thermally conductive material such as metal.

The present invention further relates to a heat sink that can more efficiently remove or divert heat from a curing light device when a reduced weight of heat sink material is used.

The present invention includes a heat sink having at least one suitable phase change material including organic materials, inorganic materials and combinations thereof. These materials can undergo substantially reversible phase changes, and can typically go through a large, if not an infinite number of cycles without losing their effectiveness.

In one embodiment, a rechargeable dental curing light including at least one heat sink having at least one phase change material is disclosed. The heat sink includes a block of thermally conductive material such as metal having a bore or void space which is at least partially filled with a phase change material.

In another embodiment, a bleaching light including at least one heat sink having at least one phase change material is disclosed. The heat sink includes a block of thermally conductive material such as a metal having a bore or void space which is at least partially filled with a phase change material.

The heat sink of the present invention may be constructed by hollowing out a thermally conductive material, such as metal, and at least partially filling the void with at least one phase change material prior to capping it to secure the phase change material inside, such that the at least one phase change material is substantially contained or surrounded by a thermally conductive material such as a metal normally used in the construction of a conventional metal heat sink.

Alternatively, the heat sink can be cast or machined with thermally conductive material such as metal walls surrounding a bore or void. The bore or void is partially filled with at least one phase change material prior to capping it to secure the material inside.

In one embodiment, the inventive heat sink may be used by itself. In another embodiment, it may be used in addition to a fan, in conjunction with a conventional metal block heat sink or combinations thereof.

The inventive heat sink may be installed into a dental curing light or bleaching light in the same manner a conventional a metal block heat sink is installed, such as by attaching it to the heat source, i.e., the light source, which may be a gas-filled arc light such as a halogen source, a Xenon light, a metal halide, a fluorescent light source semiconductor light emitting devices, laser emitting light source, light emitting chips such as a light-emitting diode (LED), a solid-state LED, an LED array, or combinations thereof, or by attaching it to another heat sink.

### BRIEF DESCRIPTION OF THE DRAWINGS

FIG. 1 shows a perspective view of an embodiment of a heat sink of the present invention;

FIG. 1a shows a perspective bottom view of the embodiment of the heat sink of FIG. 1;

FIG. 2 shows an explode view of another embodiment of a heat sink of the present invention;

FIG. 2a shows a perspective bottom view of the embodiment of FIG. 2 without a cap;

FIG. 3 shows a side profile view of the embodiment of the heat sink of FIG. 1 of the present invention;

FIG. 4 shows a perspective view of a cap of an embodiment of the heat sink of FIG. 1;

FIG. 4a shows a side view of the embodiment of FIG. 4;

FIG. 4b shows a top view of the embodiment of the cap of FIG. 4;

FIG. 4c shows a bottom view of the embodiment of the cap of FIG. 4;

FIG. 5 shows a cross-sectional view of the heat sink of FIG. 1;

FIG. 6 shows a cross-sectional view of another embodiment of a heat sink of the present invention;

FIG. 7 shows an exploded perspective bottom side view of an embodiment of a heat sink of the present invention; and

FIG. 8 shows a cross-sectional view of a curing light according to one embodiment of the invention.

### DETAILED DESCRIPTION OF THE INVENTION

The detailed description set forth below is intended as a description of the presently exemplified embodiments of the present invention and is not intended to represent the only forms in which the present invention may be prepared or utilized. The description sets forth the features and the steps for practicing the present invention and is to be understood, however, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the exemplified methods, devices and materials are now described.

A curing light system useful for curing light activated composite materials or a light system useful for whitening teeth typically comprises a light module housed in an encasement or housing.

Using a phase change material enclosed inside a substantially hollow, thermally conductive material such as a metal instead of a conventional solid metal heat sink can decrease the weight of the curing light and increase the time the heat sink takes to reach the “shut off” temperature, as it is called in the dental curing light industry. The period prior to reaching the shut off temperature is called the “run time”. Increasing the “run time”, i.e., the time when the light can remain on, increases the time when a dentist can perform his curing procedure.

Phase change materials may include organic materials, such as paraffin waxes, 2,2-dimethyl-n-docosane (C₂₄H₅₀), trimyristin, ((C₁₃H₂₇COO)₃C₃H₃), 1,3-methyl pentacosane (C₂₆H₅₄), other polyethylene waxes, ethylene-bis-stearamide, N,N-ethylene-bis-stearamide, or similar, which may be used alone or in mixtures thereof. Inorganic materials such as hydrated salts including sodium hydrogen phosphate dodecahydrate (Na₂HPO₄.12H₂O), sodium sulfate decahydrate (Na₂SO₄.10H₂O), ferric chloride hexahydrate (FeCl₃.6H₂O), TH29 (a hydrated salt having a melting temperature of 29° C., available from TEAP Energy of Wangara, Australia) or similar, which may be used alone or in mixtures thereof. Other inorganic materials may include metallic alloys, such as Ostalloy 117 or UM47 (available from Umicore Electro-Optic Materials) is also contemplated. Exemplary materials are solids at ambient temperature, having melting points between about 30° C. and about 50° C., more for example, between about 35° C. and about 45° C. Also, the exemplary materials may have a high specific heat, for example, at least about 1.7, more for example, at least about 1.9, when they are in the state at ambient temperature. In addition, the phase change materials may, for example, have a specific heat of at least about 1.5, more for example, at least about 1.6, when they are in the state at the elevated temperatures.

Some of the phase change materials mentioned above may be recyclable in that they may undergo phase changes for an almost infinite number of times. Others may be more endothermic agents and thus may have a limited life cycle unless handled under a controlled environment. These endothermic agents may lose their effectiveness as a phase change material even when handled under a controlled environment.

For some metallic alloys, though their heat of fusion may be low, they may be better thermal conductors than other phase change materials with higher heat of fusion. Thus a mixture of a metallic alloy with one or more of the other inorganic or organic phase change materials may be used to increase heat conductivity within the phase change material.

Thermal conductivity of the materials is a factor used in determining the rate of heat dissipation. For example, the thermal conductivity of the phase change material is at least about 0.5 W/m° C. in the state at ambient temperature, and at least about 0.45 W/m° C. in the state at elevated temperature.

In general, the phase change material may be contained inside a thermally conductive housing or casing, such as a metal housing. The housing defines a bore, which may be of any shape, but is for example, of a circular or a rectangular cross-section. The metal casing or wall of the bore acts to contain the phase change material, and to also aid in conducting heat to and away from the phase change material. The thinner the wall, the more phase change material can be present for a given size of the heat sink, and the less it contributes to the weight of the curing light. However, the thinner the wall, the less efficient the wall may be in conducting heat away from the phase change material and the longer it will take to return the phase change material to ambient temperature and its original state, so that it can function as a heat sink again. For example, a wall thickness typically ranges from about 1 mm to about 2.5 mm, more for example, from about 1 mm to about 1.5 mm for balance of properties.

Also, the housing may be constructed to have a large surface area. For example, a structure having fins or other features on its outside surface may serve to increase the surface area for heat conduction or convection. A spherical structure may therefore be less desirable. Such fins or other surface area increasing features may also be incorporated into the bore to increase the contact area between the thermally conductive casing and the phase change material, thus permitting faster and more efficient transfer of heat between the thermally conductive casing and the phase change material. Also, as noted above, a mixture of organic or inorganic phase change material with a metallic alloy may also increase the efficiency of heat transfer inside the phase change material.

It may also be desirable for the thermally conductive casing to be in good thermal contact for heat transfer from the light source. This may be accomplished with a smooth, thermally conductive surface with a large area of contact. Also, thermal coupling may be achieved with thermally conductive interface materials such as thermal epoxy or other thermally conductive adhesives. Interface materials that are electrically insulating are also useful in isolating the light source from the heat sink in an electrical sense without losing thermal conductivity.

Some phase change material may also have a high latent heat of fusion to store significant amounts of heat energy, as noted above. A latent heat of fusion of at least about 30 kJ/kg, is desirable, with a latent heat of fusion of at least about 200 kJ/kg being more desirable.

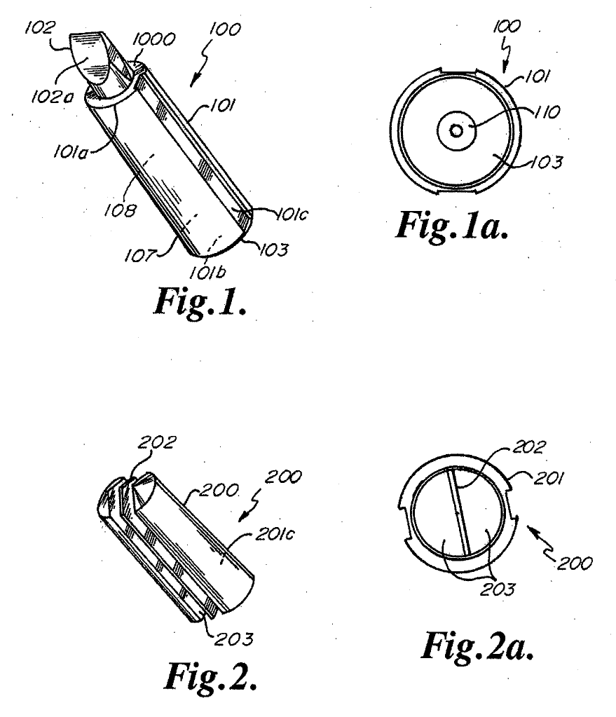

In one embodiment, a heat sink 100 may have a substantially cylindrical form, as shown in FIG. 1. The housing 101 may be made of copper, aluminum, or any other relatively light weight metal having good thermal conductivity. The housing includes a substantially hollow interior 107, and is partially filled with a solid phase change material 108, such as sodium hydrogen phosphate dodecahydrate (Na₂HPO₄.12 H₂O) or any of the materials mentioned above, to at least about 50% by volume of the hollow interior 107, as shown in FIG. 5. Depending on the vapor pressure of the phase change material chosen, the phase change material may be present up to about 80% by volume of the capacity of the hollow interior 107. One end of the housing 101 is closed and the closed end is shown as 101a. The other end of the housing 101 is open, to facilitate filling of the heat sink with the phase change material. The open end 101b, as is shown also in FIG. 5, may be covered with a capping device 103, which may be made of the same material as the rest of the heat sink housing. The heat sink may also include an interface feature 102 for contact with at least one heat generating source, such as a light source.

In the embodiment as shown, the interface feature 102 may be integrally formed with the substantially cylindrical housing if the housing is formed by molding. It may also be machined, if the housing is made by machining.

In one embodiment, the interface feature 102 includes a substantially flat surface 102a for providing a mounting surface and a good thermal interface with a heat generating source, for example, a light source such as an LED. The flat surface 102a is exemplified here as a sloping surface, making an angle with the top portion of the closed end 101a of the housing 101. The interface feature may be of the same diameter as the diameter of the closed end of the housing 101, or it may be of a smaller diameter, leaving at least one shoulder portion 1000. In another embodiment, the interface feature 102 may be of other shapes and dimensions, as long as these other shapes also provide mounting surface or surfaces for light source or sources.

The outside surface of the housing 101 may be constructed with at least one valley or channel 101c, running substantially the length of the outside surface of the housing 101. The valley or channel 101c serves as a place for positioning wiring components for connecting to a light source or sources. The valley or channel may be of a uniform dimension along the length of the housing 101 or may be of irregular width. The valley 101c may also be smooth or rough. As exemplified, the housing 101 includes two parallel channels or valleys, approximately directly opposite each other. In addition to serving as a place for wiring, the valleys 101c also add to the surface area of the heat sink as well as serving to lighten the weight of the heat sink.

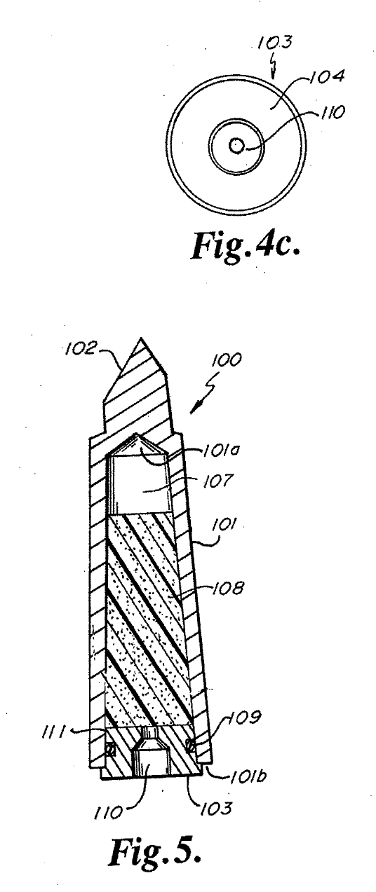

FIG. 1a shows a perspective bottom view of the embodiment of the heat sink in FIG. 1, where the open end is closed by means of a capping device 103, which may be in the shape of a simple cap, or of a more complicated construction, as shown in FIG. 4, described below in more detail.

As exemplified, the capping device 103 is shaped to be fitted inside the open end 101b of the housing 101. The capping device includes a channel or dent 110, adapted for positioning a thermistor or other thermal sensors. The capping device 103 may be held in place inside the open end 101b of the housing by a number of ways. For example, it may be held in place by at least one formation 111, as shown in FIG. 5, adapted for compression fitting the circumference of the capping device against the inside wall of the housing 101, as described in more detailed below.

FIG. 2 shows an exploded perspective view of another embodiment of a heat sink of the present invention. A heat sink 200 includes a substantially cylindrical housing exterior 201, a substantially hollow interior 201c and a blade-like divider 202 disposed within its housing 201. The blade-like divider 202 may run substantially the length of the interior 201c of the housing 201, or it may be of any other length.

The housing 201 may be made of the same thermal conductive material, as noted above. In one embodiment, the blade-like divider 202 may be made of the same material as the housing 201. In another embodiment, the blade-like divider may be made of a different thermal conductive material as the housing 201.

In the exemplified embodiment, the blade-like divider 202 serves to partition a hollow interior 203, as is shown in FIG. 2a. The blade-like divider, like the valley or channel on the outside of the housing, as shown in FIG. 1, may also serve to increase the surface area of contact between a thermally conductive material and the phase change material for more efficient heat conduction, as discussed above and also below. In another embodiment, as noted above, a metallic alloy such as those mentioned above may be mixed with one or more of the other inorganic or organic phase change materials may be used to increase heat conductivity within the phase change material.

A capping device 203 may be fitted into the open end of the housing 201, as is described above, to contain a phase change material.

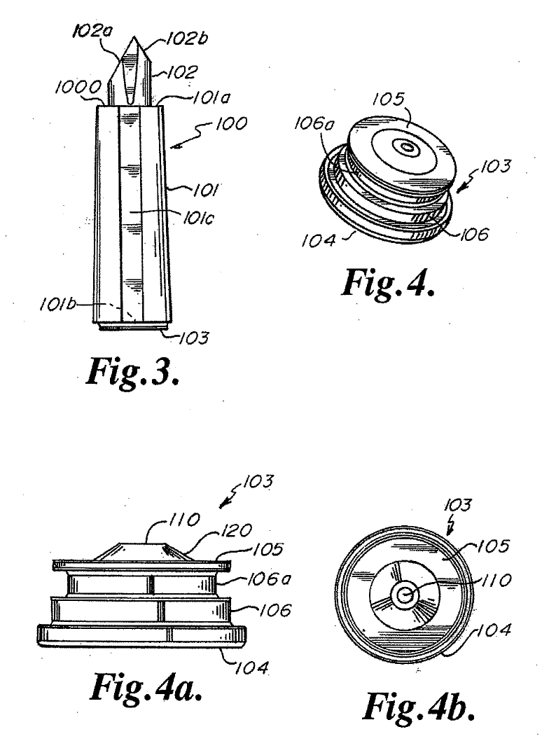

FIG. 3 shows a side profile view of the heat sink 100 of FIG. 1. The interface feature 102 shows here has two substantially flat surfaces of unequal sizes, a larger surface 102a and a smaller surface 102b, each adapted for providing a mounting surface and a good thermal interface with a heat generating source, if desired.

As shown in FIG. 3, the interface feature 102 is of a smaller diameter as the diameter of the closed end of the housing 101, resulting in shoulder-like portion 1000 protruding from beneath the interface feature 102.

FIG. 4 shows a perspective view of the exterior of a capping device 103, adapted for fitting into a heat sink, as shown in FIGS. 1, 2, 6 and 7. The end portion 105 is adapted to be inserted into the hollow interior 107 of a heat sink, such as shown in FIG. 1, and the second end portion 104 is exposed on the outside of the heat sink 100. A circumferential groove 106a may be included in the vertical wall section 106. This groove is adapted to accommodate an o-ring, a gasket, or other sealing features to provide a air and/or moisture tight seal.

FIG. 4a shows a side view of the capping device 103 exemplified in FIG. 4. The capping device, as shown, includes a channel or dent 110, adapted for positioning a thermistor or other thermal sensors. The dent 110 may be present in a raised portion or mound 120 of the capping device 103. The mound 120 is of a smaller diameter as the rest of the capping device.

As noted above, the capping device 103 may be held in place inside the open end 101b of the housing by a number of ways. In the example as shown in FIG. 5, it is held in place by at least one formation 111, adapted for compression fitting the larger circumference of the end portion 105 of the capping device 103 against the inside wall of the housing 101. A circumferential groove 106a is shown here as having a substantial vertical portion having a reduced diameter. The groove 106a may be molded or machined into the capping device. As noted, this groove is adapted to fit an o-ring, a gasket or other sealing features for sealing the open end of the housing.

The bottom or exposed end 104 of the capping device 103 has a substantially equal diameter or dimension as the outside diameter or dimension as the open end of the housing 101, so that the capping device may be flush with the outside vertical wall of the housing 101. In another embodiment, the diameter of the bottom end 104 of the capping device 103 may be of a larger diameter or dimension as the open end of the housing 101, so that the capping device protrudes from the side of the heat sink to facilitate removal of the capping device 103, if desired.

FIG. 4b shows a top view of the capping device 103 of FIG. 4. As exemplified in this view, the larger diameter of the bottom end 104 than that of the vertical wall section 106 is clearly shown.

FIG. 4c shows the bottom view of the capping device 103 of FIG. 4, where the depression 110, adapted for holding a thermistor or other thermal sensors, is clearly shown. The depression as shown, has a circular cross-section, but may other shape may be suitable.

FIG. 5 shows a cross-sectional view of a heat sink 100 of the present invention. The hollow interior 107 includes an open end 101b, which is shown to be capped with a capping device 103, and a closed end 101a. The hollow interior 107 is shown to be substantially filled with a solid phase change material 108, which may include any of the materials described before. The capping device 103 is shown in place, sealing the hollow interior 107 by means of an o-ring 109. The capping device 103 may be held in place by at least one formation 111, adapted for compression fitting the circumference 106 (as shown in FIG. 4a) of the capping device against the inside wall of the housing 101. The cap may also include a channel 110, adapted, for example, to house a thermistor or other thermal sensors. The thermistor or other thermal sensors may be fixed to the channel with a thermally conductive adhesive, such as a structural or permanent adhesive, or a reactive adhesive, for example, an epoxy, a silicone adhesive, a contact cement, or a cyanoacrylate based adhesive, an acrylic-based, a polyurethane-based, a polyamide-based, a styrene copolymer-based, a polyolefin-based or similar, to allow the sensor to provide temperature information to a curing light control system to keep the curing light from becoming too hot to handle or to be over-heated.

In some embodiments, the capping device 103 may also be sealed to an open end of the housing a structural adhesive, such as those mentioned above in connection with the thermistor. The adhesive seals any pin holes that may exist. In other embodiments, pin holes or vent holes may be desirable to allow gas to escape. To minimize any liquid phase change material from escaping, a vapor impermeable/moisture permeable layer or film may be used to cover the holes.

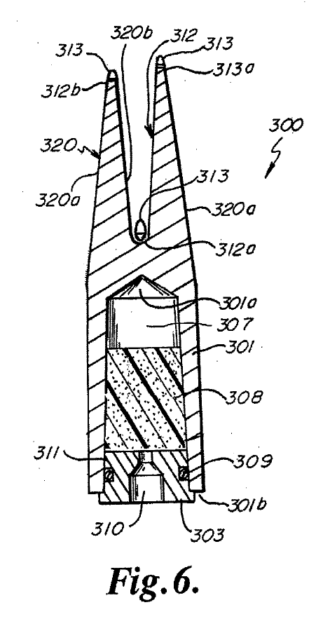

In some embodiments, the heat sink includes a well and an LED or laser diode chip or chips may be mounted in the well. Light emitted from the side(s) of the LED or laser diode chip or chips may be reflected off the walls of the well to travel in a desired direction. In other embodiments, the well may be deep, as shown in FIG. 6 below.

FIG. 6 shows a cross-sectional view of another embodiment of a heat sink 300 of the current invention. In this embodiment, the housing 301 includes a well 312 in place of a protruding feature, such as an interface feature, as shown above. The exemplified embodiment shows an elongated or substantially cylindrical heat sink 300, except that it has a curved structure, for example, a well or depression 312. The well 312 may be deep, having side walls 320 with the proximal portion 312b being at the top of the well and the distal portion 312a at the bottom of the well, adapted for positioning at least a light source such as an LED or LED array 313 at either its distal end 312a or the proximal portion 312b of the well or depression 312, to diffuse the concentration of heat generation.

The proximal portion of the well 312 may include at least two mounting platforms 313a, located, for example, approximately opposite each other, and at least one mounting platform 313a located towards the distal portion 312a of the elongated heat sink, for mounting at least one light source 313. These mounting platforms may be surfaces on the heat sink housing, as discussed before.

The heat sink 300 may also include at least one channel or valley, which may or may not run the length of the housing 301, as discussed above. A channel or valley (not shown) may also be present along the inner side wall 302b for wiring components.

The light sources 313 may be capable of emitting the same or different wavelengths. This heat sink construction may be capable of more effective heat dissipation by not concentrating the heat product at one location.

In one embodiment, each of the light sources 313 may include a light emitting diode (LED), or an LED array. Each of the LEDs (or LED arrays) emits light useful for initiating curing of a light activated material. In one embodiment, the combined light sources 313 may emit light of multiple wavelengths for activating a photoinitiator or multiple photoinitiators.

In one embodiment, the well 312 may accommodate the placement of LEDs 313 within the well and/or at the proximal portion 312b. Heat from the LEDs 313 may be conducted away by the housing 301. The side wall 320 of the well may be of a solid thermal conductive or metallic material. The material may be the same thermal conductive or metallic material as the rest of the housing 301, without a hollow interior. In another embodiment, the side wall 320 includes an inner side wall 320a and an outer side wall 320b surrounding a partially hollow interior of the well 312. This space may be filled with some phase change material 308 as well, or may provide expansion space for the phase change material 308 when it changes from one phase, occupying one space, into a phase occupying a larger space.

A capping device 303 may also be used to seal the hollow interior 307 at the open end 301b with an o-ring 309 and a formation 311 for a compression fit. A thermistor or other thermal sensor may be disposed in the channel 310 and fixed with a thermally conductive adhesive, such as those mentioned above, again to allow temperature information to be passed to a curing light control system. As discussed above, the capping device 303 may also be sealed with an adhesive to seal any pin holes that may exist. In other embodiments, pin holes or vent holes may be desirable to allow gas to escape. Again, to minimize any liquid phase change material 308 from escaping, a vapor impermeable/moisture permeable layer or film may be used to cover the holes.

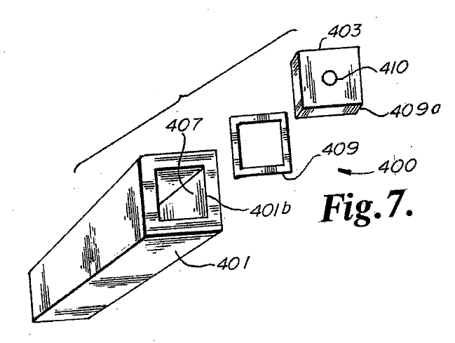

FIG. 7 shows another embodiment of a heat sink of the present invention. The heat sink 400 is of a square cross-section, having a housing 401, and a substantially hollow interior 402. The heat sink may be an elongated heat sink as shown, and the interior may either be of a substantially rectangular shape or a cylindrical shape.

This heat sink may be fitted again with a capping device 403, with a depression at the top of the capping device. An elastomeric gasket 409 may be again disposed about a channel 409a in the capping device.

The interior of the housing may also include a divider in one embodiment and no divider in another.

This heat sink may also be filled with a phase change material, as discussed above.

The gasket or o-ring may be made of any elastomeric or rubber material for providing a seal to minimize exposure of the phase change material to the environment outside of the housing.

In one embodiment, the housing may also have vent holes to allow the escape of gases, as mentioned above. In such embodiments, the recyclability of the heat sink may be reduced unless completely recyclable phase change materials are used. In one embodiment, these vent holes may also be covered with a vapor permeable, moisture impermeable layer, as mentioned above, surrounding the phase change material on the inside of the housing. In another embodiment, the vapor permeable, moisture impermeable layer may surround at least the portion of the housing having the vent holes on the outside of the housing. Examples of vapor permeable and moisture impermeable materials may include a water vapor permeable polyurethane film formed from a hot melt moisture curing adhesive containing at least one isocyanate functional polyurethane (which may be a reaction product of a component that contains NCO groups and a diol component with at least one linear dihydroxy polyester, formed from a diacid constituent and a diol constituent, the diol constituent may be a dihydroxy poplyether having a weight average molecular weight of at least 1000, and the ratio of OH:NCO in the isocyanate functional polyurethane is between 1.0:1.6 and 1.0:2.6) (disclosed in U.S. Pat. No. 5,851,661, the content of which is incorporated herein by reference); a film layer formed from a composition of a non-curing thermoplastic composition containing ethylene methacrylic acid copolymer or a polyether block amide, and at least one diluent such as a plasticizer (disclosed in U.S. Pat. No. 6,432,547, the content of which is incorporated herein by reference); a substrate with a thermoplastic composition made with a non-contact coating method to produce a substantially continuous coating of a variety of adhesives (such as polyethylene, polypropylene, copolymers of olefins, especially ethylene, and (meth-) acrylic acid; copolymers of olefins, such as ethylene, and (meth-) acrylic acid derivatives of (meth-) acrylic acid esters; copolymers of olefins, such as ethylene, and vinylic compounds of vinyl carboxylates such as vinyl acetate; thermoplastic rubbers (or synthetic rubbers) such as styrene-isoprene-styrene, styrene-butadiene-styrene, styrene-ethylene/butylene-styrene and styrene-ethylene/propylene-styrene block copolymers available in commerce under the tradenames of Kraton®, Solprene®, and Stereon®; metallocene-catalyzed polymers, especially based on ethylene and/or propylene; polyolefins such as ethylene, polypropylene and amorphous polyolefins (atactic poly-alpha-olefins) such as Vestoplast® 703 (Huls); polyesters; polyamides; ionomers and corresponding copolymers; and mixtures thereof), as disclosed in U.S. Pat. No. 6,843,874, the content of which is incorporated herein by reference; or similar.

Any embodiment of the heat sink described above may be constructed as a module so that it may be changed or exchanged when needed.

The embodiments of heat sink described above may be used in a curing light system. The curing light may be a hand-held portable curing light system operated by batteries or a chair side curing light system operated by AC power. A heat sink including a phase change material may be installed in the curing light or a photobleaching light device in the same manner a conventional metal block heat sink is installed. As mentioned above, some curing lights and photobleaching lights are generally supported when in use, therefore the weight of the device is not as problematic. However, a more efficient heat sink may be beneficial and can nevertheless lead to the construction of a more compact bleaching light.

The heat sink including at least one phase change material may be used by itself or in conjunction with a conventional metal heat sink or a fan. In the case of a light source used in whitening teeth, an additional cooling system such as a liquid coolant may also be used.

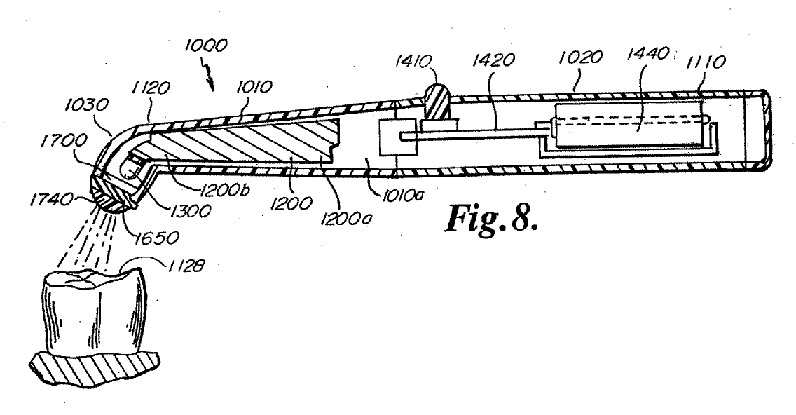

FIG. 8 shows an embodiment of a curing light 1000 of the present invention, having a light module housing 1010 including a distal end 1110, a proximal end 1120, a handle 1020 towards its distal end and a neck and head portion or body 1030 on its proximal end at an angle to the handle portion 1020. The light module housing 1010 has a substantially cylindrical shape having a substantially hollow interior 1010a with at least one heat sink 1200 located in the light module housing 1010. The heat sink 1200 may have a longitudinal axis, or may be of any configuration adapted to promote effective thermal management within the curing light 1000. In one embodiment the head and neck portion 1030 may also include a light guide, such as the internal light guide 1700 shown here in FIG. 8. In other embodiments, the curing light may include an external light guide.

In some embodiments, a lens cover 1650 may be located towards the proximal end 1120 of the light module housing 1010, as shown. In one embodiment, the lens cover 1650 may be a transparent window through which light travels before striking a composite material or surface to be cured or whitening material 1128 to be acted on. Some examples of the housings include sealed plastic and sealed metal ends with a window.

In other embodiments, the cover 1650 may be a focusing device, which may include a focusing lens or dome 1740 for focusing the light towards a target surface 1128. In another embodiment, the housing 1010 may have a focusing dome 1740 integrally bonded to or formed or molded with the housing, to focus light emitted by the laser diodes or the light emitting diodes before delivering it to a remote location. Thus, the housing may be constructed therefore not only to serve to protect the light source, but also serve to focus light. The focusing dome or lens 1740 may also act as a device for modifying the footprint or varying the diameter of the light beam exiting the proximal end 1120 of the housing 1010, in order to more correctly direct the beam of light, either at a smaller target area or over a wider target area. The light module housing 1010 also houses and protects, for example, electronic circuits 1420 and a DC battery pack 1440.

Referring again to FIG. 8, one embodiment includes an elongated heat sink 1200 having a distal end 1200a and a proximal end 1200b. The heat sink 1200 may be located in the light module housing 1010 with the proximal end 1200b being situated closer to the proximal end 1120 of the housing 1010. The heat sink 1200 may also be in any other shape. At least one mounting platform (not shown) or simply a surface may be located at the distal end 1200a, and at the proximal end 1200b of the elongated heat sink 1200. When other shapes of the heat sink 1200 are included in the invention, the mounting platforms may be located at the proximal or distal surface or portion.

Mounted on each of the mounting platforms or surfaces is a light source 1300. The light source 1300 is, for example, an LED or an LED array. In one embodiment, the light sources 1300 may be located towards the proximal end of the housing 1010, so that they are close to the target area. In another embodiment, the device is fitted with a light guide 1700 to keep one or more of the light sources away from the target. The light guide 1700 here may be an extension of the housing 1010.

In some embodiments, the chips of the light source 1300, when used, may be collectively located on a single heat sink 1200 for heat dissipation or individually seated to its own heat sink. In some embodiments, the light source 1300 may be seated on a larger heat sink 1200 with electrode channels.

Also, in some embodiments, when chips are used, the heat sink 1200 including phase change material of the present invention may be in direct or indirect contact with the light emitting chip or chips 1300. After the phase change material absorbs the heat generated by the chips 1300, heat may then be dissipated. A conventional metal heat sink may be mounted adjacent to the heat sink 1200 of the present invention including at least one phase change material, either beside or beneath it. A fan may also be provided in lieu or in addition to the conventional metal heat sink.

In one embodiment, single or multiple LED chips or laser diode chips 1300 may be located on a conventional metal block heat sink, which directly absorbs heat generated by the light source or sources 1300, and the heat sink 1200 including at least one of the phase change material absorbs the heat coming from the thermally conductive or metal block. The heat sink 1200 including at least one phase change material may dissipate heat coming from the thermally conductive or metal block by being mounted adjacent to, either beside, or beneath the conventional metal block heat sink.

In another embodiment, the chips of the light source 1300 are either collectively located on a single heat sink 1200 including phase change material for heat dissipation or individually seated to its own heat sink 1200′ including phase change material.

In other embodiments of the invention, a light source 1300 including LED's or laser diode chips may be located on a face of the heat sink 1200 and around the periphery of that face of the heat sink. In this configuration, more LED's or laser diode chips 1300 be placed on the heat sink 1200 either to achieve a more powerful light or to accommodate the necessary number of wavelengths of light that are desired to be produced.

In addition, electrodes providing power to the laser or the LED chips 1300 may also be included in the housing 1010.

At the beginning of operation, the phase change material may be, for example, in a solid state at ambient temperature, although a liquid may also be used if special provisions are made for containing the gas produced during phase change. As heat is generated by the light source or sources, it is conducted away by the thermally conductive or metal casing or metal wall and absorbed by the phase change material. The solid or liquid absorbs heat from the casing and undergoes a phase change to a liquid or gas, respectively. Some sublimation may also be happening. When a substantial proportion of the material has undergone phase change to a new state or phase, an internal thermal sensor may be provided to effect the shut off of the curing light or bleaching light at a given temperature. After reaching this shut off temperature, the liquefied or gasified phase change material then begins to dissipate heat, when the thermally conductive or metal casing is removed from any heat generating source, for example, the light source is turned off. This heat dissipation is again through the thermally conductive or metal casing, in an attempt by the phase change material to return to its initial state of solid or liquid, respectively. When most of the phase change material comes substantially close to ambient temperature, it will then remain a solid or liquid until it once again experiences a rise in temperature to its melting or gasifying point and the process is repeated. Since the phase change material undergoes substantially reversible phase changes, it may typically go through a large, if not an infinite number of cycles without losing its effectiveness.

In one embodiment, the light from the light source 1300 exits the housing 1010 and travels directly to a curing surface 1128 without first going through a light guide or fiber optic 1700. In other embodiments, the light travels from the light source 1300 to a curing surface 1128 by first going through a light guide or fiber optic 1700.

The light source 1300 may be, for example, located in a handle that may be manipulated by a user in order to direct light emitted by the light source 1300 to composite materials 1128 to be cured. In some embodiments, at least a portion of handle is flexible that may be bent in any desired direction for ease of use. The flexible portion includes at least a soft protective material surrounding at least one bendable wire.

The heat coming out of the housing may be dissipated by a heat sink 1300 including the phase change material, a conventional metal block, or a fan, located in the handle, or just by ambient air.

As discussed before, when multiple light sources 1300 are used, they may emit multiple wavelengths of light so that composite materials having photoinitiators sensitive to different wavelengths may all be cured with a single light source 1300. In some embodiments, diode lasers or light emitting diodes 1300 may be arranged in an array on an appropriate base or fixture in order to provide greater light power or to provide a varying diameter light source 1300 if a concentric array is used. Further, when an array of laser or light emitting diode chips 1300 is used, a light having single or multiple wavelengths may be achieved by placing the chips 1300 with different wavelength in the array.

Furthermore, the curing or photobleaching light system may be equipped with a control module with AC or DC power 1440. The control module powers and controls the curing or photobleaching light system so that appropriate light for curing a composite material or for bleaching a photoactive bleaching composition is provided at a desired light intensity for any desired time duration. An on/off switch and an indicator 1410 for low battery power can also be provided.

In some embodiments of the invention a battery charger is provided for charging one or more batteries used to power the light source 1300. When the battery is being charged, the curing or photobleaching light may still be used for treatment because power can be drawn from the charger to power the curing light.

The present invention is further exemplified in the following example:

### EXAMPLE

A heat sink embedded in a dental curing light was constructed as follows:

Composition and property of phase change material used:

Phase change material (PCM): Sodium Hydrogen Phosphate Dodecahydrate (Na₂HPO₄.12 H₂O) having the following properties was used:

Melting Point: 36° C.
Heat of Fusion: 280 kJ/kg
Specific Heat: 1.94 kJ/kg° C. (solid), 1.60 kJ/kg° C. (liquid)
Density: 1520 kg/m3 (solid), 1450 kg/m3 (liquid)
Thermal Conductivity: 0.514 W/m° C. (solid), 0.476 W/m° C. liquid)

The thermally conductive housing: a copper casing (tellurium copper 145), having wall thickness of about 1.5 mm.

Preparation:

The phase change material was heated for 45 minutes at 55° C. in an oven until melted. 1.2 mL of phase change material in liquid phase was loaded into the hollow copper casing of the heat sink using a syringe. The heat sink was cooled with a fan for 30 minutes before a cap was pressed into place to seal the chamber. A thermistor was placed into the channel of the cap and sealed into place with thermal epoxy. Additional thermal epoxy was also applied to the interior of the cap to provide further sealing.

Test:

The constructed heat sink of the above specified configuration was tested in a curing light in accordance with the present invention. The testing consisted of determining the run-time of the curing light when utilizing a heat sink including a phase change material in comparison to a heat sink without a phase change material. Run-time testing determined the operational time prior to the curing light shut-off temperature. A rise of temperature to 40° C. from an ambient temperature of 25° C. was obtained. The curing light employing a heat sink including a phase change material averaged a run-time of greater than 20 minutes (a total of 20 samples with approximately the same construction was run) and the curing light employing a comparable heat sink except without a phase change material averaged a run-time of about 8 minutes (a total of 67 samples were run).

The heat sink of the present invention demonstrated a superior performance when compared to conventional solid metal block heat sinks, even at a lower weight.

Although the present invention has been described in detail with respect to some embodiments, it will be appreciated by those of ordinary skill in the art that the invention can also be embodied in other forms without departing from the spirit or essential character hereof. The present description is therefore considered in all respects to be illustrative and not restrictive. The scope of the present invention is indicated by the appended claims, and all changes that come within the meaning and range of equivalents thereof are intended to be embraced therein.

1. A heat sink useful in a photocuring or photobleaching light system comprises:
a thermally conductive housing comprising an open end, a closed end, and a substantially hollow interior; and
a capping device comprising a formation adapted for compression fitting in the open end of the thermally conductive housing;
wherein said housing is partially filled with at least one phase change material adapted to absorb heat generated by a light source and undergoes substantially reversible phase changes.

2. The heat sink of claim 1 wherein said phase change material is selected from a group consisting of organic materials, inorganic materials and combinations thereof.

3. The heat sink of claim 2 wherein said organic phase change material is selected from the group consisting of paraffin waxes, 2,2-dimethyl-n-docosane (C₂₄H₅₀), trimyristin, ((C₁₃H₂₇COO)₃C₃H₃), 1,3-methyl pentacosane (C₂₆H₅₄), polyethylene waxes, ethylene-bis-stearamide, N,N-ethylene-bis-stearamide, and mixtures thereof.

4. The heat sink of claim 2 wherein said inorganic phase change material comprises inorganic hydrated salts

5. The heat sink of claim 2 wherein said inorganic phase change material is selected from the group consisting of sodium hydrogen phosphate dodecahydrate (Na₂HPO₄.12 H₂O), sodium sulfate decahydrate (Na₂SO₄.10H₂O), ferric chloride hexahydrate (FeCl₃.6 H₂O), TH29, metallic alloys and mixtures thereof.

6. The heat sink of claim 1 wherein said phase change material is substantially surrounded by thermally conductive walls.

7. The heat sink of claim 1 wherein said phase change material is a solid at ambient temperature.

8. The heat sink of claim 1 wherein said phase change material has a melting point between about 30 to about 50 degrees C.

9. The heat sink of claim 1 wherein said phase change material has a melting point between about 35 to 45 degrees C.

10. The heat sink of claim 1 wherein said phase change material has a specific heat of more than about 1.7 at ambient temperature.

11. The heat sink of claim 1 wherein said phase change material has a specific heat of more than about 1.5 at elevated temperatures.

12. The heat sink of claim 1 wherein said phase change material has a thermal conductivity of at least about 0.5 W/m° C. at ambient temperature.

13. The heat sink of claim 1 wherein said phase change material has a thermal conductivity of at least about 0.45 W/m° C. at elevated temperatures.

14. The heat sink of claim 1 wherein said housing comprises a blade-like divider for partitioning the substantially hollow interior.

15. The heat sink of claim 1 wherein said housing comprises an interface feature comprising a substantially flat surface adapted for mounting a light source.

16. The heat sink of claim 1 wherein said phase change material is substantially surrounded by a vapor permeable and moisture impermeable film.

17. The heat sink of claim 1 wherein said housing comprises vent holes.

18. The heat sink of claim 17 wherein at least a portion of the housing comprising the vent holes is substantially surrounded by a vapor permeable and moisture impermeable film.

19. The heat sink of claim 1 wherein said housing comprises a cylindrical or a rectangular cross-section.

20. The heat sink of claim 1 wherein said housing comprises at least one channel running the length of the housing along its outside, said channel is adapted for positioning wiring components.
